(19) United States
(12) Patent Application Publication
(10) Pub. No.: US 2008/0230545 A1
(43) Pub. Date: Sep. 25, 2008

(54) Lid and container organization method and apparatus

(76) Inventor: Ross Nathaniel Weene, Newport, RI (US)

Correspondence Address: Ross Weene Design, PO Box 93, Newport, RI, 02840, US

(21) Appl. No.: 12/072,605

(22) Filed: Feb. 27, 2008

Related U.S. Application Data
(60) Provisional application No. 60/904,135, filed on Feb. 27, 2007.

(51) Int. Cl. B65D 55/16; B65D 25/00; B23P 19/04

(52) U.S. Cl. 220/375; 220/694; 29/700

(57) ABSTRACT

A device providing a flexible tether between food storage containers and their specific lids, to aid in organization of and to prevent loss of the individual components. The ends of said tether have attachment means which may be affixed to a lid and to a container by a selection of several attachment systems. The device functions effectively in organizing containers and lids that have no manufactured tethering or retaining means, such that may already exist in a disorganized fashion in a consumer's inventory, where implementation of the device will maintain an organization for the future of the components.

### CROSS REFERENCE TO RELATED APPLICATIONS

This invention claims priority under 35 U.S.C. 119(e) to Provisional Patent Application Ser. No. 60/904,135 filed on Feb. 27, 2007 by applicant Ross N. Weene and entitled “Lid and Container Organization Method and Apparatus.” The content of such application is incorporated herein by reference.

### FIELD OF THE INVENTION

This invention relates to jars and containers having lids and means of retaining the lids associated with the jars or container to which the lids fit.

### FEDERAL SPONSORSHIP

No Federal funds were used to develop the present invention.

### BACKGROUND OF THE INVENTION

The present invention is directed methods and apparatus to hold lids and covers in association with ajar or container. This document will use the term “lid” and “cover” interchangeably to mean a closure device for a container or jar. The terms “container” or “jar” are also used interchangeably to denote a vessel for holding material.

Containers and lids are often specific for each other. For example, there are several manufacturers of plastic containers and lids for addressing kitchen and other household needs. The lids from one manufacturer are specific for the containers of that manufacturer. And, manufacturers vary the features of the containers and lids over time such that the lids associated with containers purchased at one point in time may not work with containers purchased at a second time.

This often leads to the frustrating situation where individuals have many containers and lids and none of the lids seem to fit the containers. It takes time and trial and error to identify a cover that will fit securely on a container.

There is a need to associate and hold lids with containers to promote order, reduce clutter and minimize frustration. However, merely securing the lid to the opening of the container interferes with the possible ability to nest and stack the containers. Furthermore, many containers and lid sets are not presently manufactured with any other means of retaining lid to container and there exists a need for an apparatus that can be easily affixed to an existing lid and container pair, to subsequently keep the two parts in association.

### SUMMARY OF THE INVENTION

Embodiments of the present invention feature methods and apparatus for retaining a lid in association with a container. As used herein, the word “association” means joined or linked but specifically excluding a closed position wherein the lid is fitted to the opening of the container. One embodiment of the present invention is directed to an apparatus comprising at least one lid attachment member, one container attachment member and one line member. The lid attachment member has means for being affixed to at least one lid. The container attachment member has means for being affixed to at least one container. The flexible line member has a first end and a second end. The first end is attached to the lid attachment member. The second end is attached to the container attachment member. The flexible member has a length to allow the first end to be secured to a lid by the lid attachment member and the second end secured to a container by the container attachment member while the lid is in a first open position and in a second closed position.

Thus, the lid is associated with the container by the attachment members and the flexible member. The container still maintains the potential ability to nest and stack into a compact form with the lid close at hand. Embodiments of the present invention are ideally suited for containers and lid commorily used to store food and the like. Such containers and lids are sold by numerous vendors under trademarks such as RUBBERMAID, TUPPERWARE and ZIPLOCK.

Preferably at least one of, and even more preferably both, the lid attachment member and the container attachment member is a pad having an adhesive for sticking to a lid. The pad is preferably molded with the flexible member as an integral unitary structure to reduce manufacturing costs. A preferred adhesive is a gummy adhesive that is non-toxic and dishwasher safe, such that would allow the attachment pad to be removed and repositioned on the lid or container. In the alternative the attachment pads are manufactured with a permanent adhesive. In this embodiment the attachment pads would be subsequently affixed to a lid and container and remain in position for the life of the individual components.

Preferably, the apparatus further comprises a protective strip. The protective strip covers the adhesive to prevent the adhesive from attaching to material and things other than a lid or container. The protective strip is removable to expose the adhesive at the time it is desired to affix the lid or container attachment member to a respective lid or container. The protective strip may be removed and discarded after exposing the adhesive.

In the alternative the protective strip is integral to the attachment member to allow one or both of the attachment members to be removed from a lid or container and the protective strip to re-cover the adhesive, to prepare for future use. For example, without limitation, one embodiment of the -present invention features an attachment member having a protective strip section and an adhesive section. The adhesive section has surface to which an adhesive is affixed. The protective strip is substantially non-sticky to the adhesive. The protective strip section and said adhesive section are separated by a connective strip or a fold. The protective strip section and the adhesive section have at least two positions. In a first position, the protective strip is folded in a closed position covering the adhesive section position and the adhesive. In the second position the protective strip is folded away from the adhesive on the adhesive section for exposing the adhesive to a lid or container. In this second position, an integral mechanical feature such as a molded clip or press-snap may maintain the protective strip in this position, so as to minimize the length of unsupported material that could potentially interfere with the nesting or otherwise normal use scenario of the lid or container.

Another embodiment of the present invention comprises an apparatus having a flexible line member and at least one attachment member integrating a means with which to mechanically join an end of the flexible line member. For example without limitation, the flexible line member has an end that joins mechanically with the lid attachment member such that the lid attachment member can be subsequently detached. The flexible line member may also have an end that joins mechanically with the container attachment member, such that the container attachment member can be subsequently detached. Preferably at least one of the lid attachment member and the container attachment member is a pad having an adhesive for sticking to a lid or container. The adhesive bond between the attachment member and the lid and/or container may be either permanent or non-permanent such that the attachment member is repositionable. The adhesive may be covered by a removable protective strip. The means of mechanical connection between the flexible line member and the lid and/or container attachment member will allow for one or both ends of the flexible line member to be subsequently removed and reattached to the joining mechanism integral to the respective attachment member. For example, the lid and/or container attachment member may be molded with a cup-shaped recess. The flexible line member may be molded with at least one spherical end intended to mate with the cup-shaped recess as in a ball and socket snap-fit arrangement. The ends of the flexible line member and the attachment members could also be molded with other mechanical mechanisms such as hook-and-loop mechanism, press-fit, or press-snap. With any of these possible arrangements the flexible line member can be separated from at least one attachment member at the mechanical interface, thusly leaving at least one attachment member still affixed to the lid and/or container, and the lid now separated from the container. As this embodiment of the invention requires a greater quantity of distinct pieces that are individually complicated, it is presented as an option for organizing higher-quality and/or larger and heavier containers and lids.

A further embodiment of the present invention comprises an apparatus having a flexible line member and a lid attachment member, container attachment member and a lid and container. The features described with respect to the attachment members can be incorporated into the lid and container. For example without limitation, the lid and the container have attachment member retaining means. The attachment member retaining means is molded into the lid or the container such as a molded snap-fit socket element, a molded clip opening, a molded attachment stud, a latch, or a hole. One embodiment features a lid or container or both having an adhesive retaining surface. This adhesive retaining surface may be an area of a smoother texture than the surrounding regions designed for receiving an adhesive mounting pad as embodied in the present invention.

Thus, I have described an apparatus for organizing and retaining a lid in association with a container. The apparatus is used in a method of the present invention with respect to such containers and lids. One embodiment of the method comprises the step of providing an apparatus having at least one lid attachment member, at least one container attachment member and a flexible line member. The lid attachment member can be affixed to at least one lid. The container attachment member can be affixed to at least one container. The flexible line member has a first end and a second end. The first end is attached to the lid attachment member and the second end is attached to the container attachment member. The flexible member has a length to allow the first end to be secured to a lid by the lid attachment member and the second end secured to a container by the container attachment member while the lid is in a first open position and in a second closed position. The method further comprises the step of affixing the container attachment member to the container and the lid attachment member to the lid to organize and retain the lid in association with a container.

Embodiments of the present invention that feature a pad having an adhesive with means for sticking to a lid or container comprise the step of sticking the attachment member to a lid or container. This easy series of steps can save time and frustration in sorting through vast collections of lids and containers.

These and other features and advantages will be apparent from reviewing the drawings of the invention and studying the description that follows.

### BRIEF DESCRIPTION OF THE DRAWINGS

FIG. 1A depicts in perspective an apparatus embodying features of the present invention;

FIG. 1B depicts in plan view an apparatus embodying features of the present invention;

FIG. 2A depicts in plan view an alternative geometry for the attachment members of the present invention;

FIG. 2B depicts in perspective alternative orientations for the integral adhesive protective sections;

FIG. 3A depicts an attachment member with integral protective strip section in a closed or protective position;

FIG. 3B depicts in cross-section the present invention with protective strips in other positions;

FIG. 4A depicts one embodiment of the present invention attached to a lid and to a container with said lid in a closed position;

FIG. 4B depicts one embodiment of the present invention attached to a lid and to a container with said lid in an open position;

FIG. 4C depicts two embodiments of the present invention attached to two respective lid and container sets wherein said sets are shown associated with the present invention and subsequently nested;

FIG. 5A depicts one embodiment of the present invention with a snap-fit ball-and-socket mechanism providing a detachable joining means between a flexible line member and an attachment pad;

FIG. 5B depicts in plan view an attachment member featuring a socket;

FIG. 5C depicts in section view an attachment member featuring a socket and a mating snap-fit spherical end;

FIG. 5D depicts one embodiment of the present invention with two snap-fit ball-and-socket mechanisms providing two points of detachment between ends of a flexible line member and attachment pads;

FIG. 6A depicts one embodiment of the present invention with a hook-and-loop mechanism providing a detachable joining means between ends of a flexible line member and attachment pads;

FIG. 6B depicts in more detail a flexible line member with an end having a hook-and-loop element;

FIG. 6C depicts in more detail an attachment pad having a hook-and-loop element;

FIG. 7 depicts one embodiment of the present invention with press-snap mechanisms providing detachable joining means between a flexible line member and attachment pads;

FIG. 8 depicts a lid and container having attachment member retaining means and the present invention attached to said means.

### DETAILED DESCRIPTION OF THE INVENTION

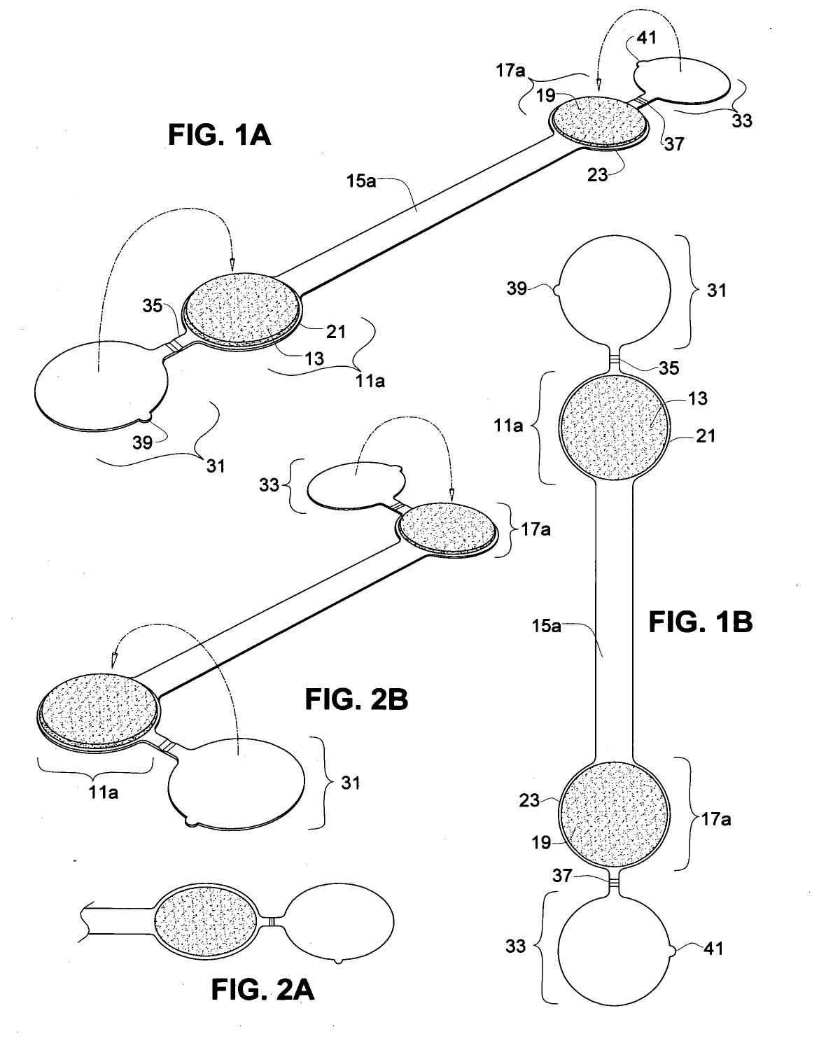

The present invention is an apparatus for retaining a lid to a storage container comprising, in reference to FIGS. 1A and 1B, a lid attachment member 11a featuring a flexible pad 21 molded with flexible line member 15a and having an integral adhesive 13. Flexible line member 15a is preferably a durable plastic, rubber or elastomeric material able to withstand repeated bending and may be built to any length to suit specific applications. The material thickness and width of flexible line member 15a shall be such to allow it to bend easily and repeatedly without fatiguing.

The invention further comprises a container attachment member 17a featuring a flexible pad 23 molded with flexible line member 15a and having an integral adhesive 19. In this embodiment of the invention, attachment members 11a,17a are identical and can be applied interchangeably on either lids or containers; therefore their designation as either lid or container attachment members is arbitrary. Preferably the pads 21,23 carry a gummy, repositionable pressure-sensitive adhesive; however in the alternative a permanent pressure-sensitive adhesive may be used. Adhesives 13,19 shall also be non-toxic and dishwasher-safe as the intended use of the present invention is for organizing food storage container and lids. Pads 21,23 can be molded to varying diameters to carry more or less adhesive suiting specific application strength requirements, but they shall not be limited in geometry and an elliptical shape as shown in FIG. 2A would also be satisfactory and would perform better on containers and lids with compound curved walls.

Referring still to FIGS. 1A and 1B the attachment members 11a, 17a are shown to have integral protective strip sections 31,33 separated by connective strips or folds 35, 37. This embodiment of the present invention is such that the attachment members 11a, 17a may be removed from a lid or container and the protective strip sections 31,33 used to re-cover the adhesive sections 13,19 to maintain their stickiness in preparation for future use. The protective strip sections 31,33 are substantially non-sticky to the adhesive sections 13,19. Extension tabs 39,41 may be molded with protective strip sections 31,33 to facilitate the operation of peeling them away from the adhesive sections 13,19. Furthermore, as in FIG. 2B, said integral protective strip sections 31,33 are not limited in their orientation and may be attached to any quadrant circumferentially around attachment members 11a,17a.

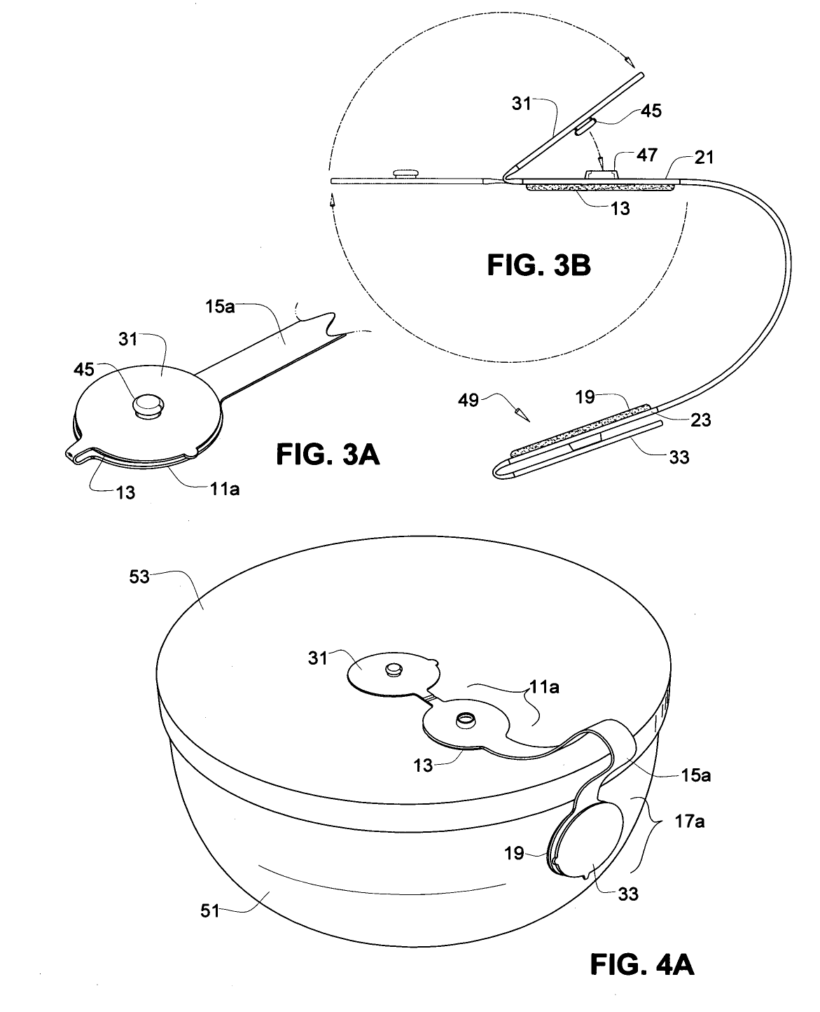

The protective strip sections 31,33 have at least two positions. In a first position, as shown in FIG. 3A, a protective strip section 31 is folded in a closed position covering the attachment member 11a and its respective adhesive 13 but not flexible line member 15a. In alternative positions; as shown in FIG. 3B as well as in FIGS. 1A, 1B and FIGS. 2A, 2B, a protective strip section 31,33 is folded away from and subsequently exposing adhesive sections 13 for attachment to a lid or container. Furthermore, a mechanical feature such as a molded clip or press-snap may be used to maintain the protective strip sections 31,33 in a position away from the adhesive 13,19 so as to minimize the length of unsupported material that could potentially interfere with the nesting or otherwise normal use scenario of the lid or container. Referring to FIGS. 3A and 3B the stud 45 of said press-snap is shown molded with the protective strip section 31 and the respective mating socket 47 of said press-snap is shown molded with pad 21, such that when said stud 45 is mated 43 with socket 47 the protective strip section 31 will organize in close adjacency with the pad 21. Said mated position 49 is depicted in FIG. 3B; protective strip section 33 is folded away from adhesive 19 and is organized adjacent to pad 23.

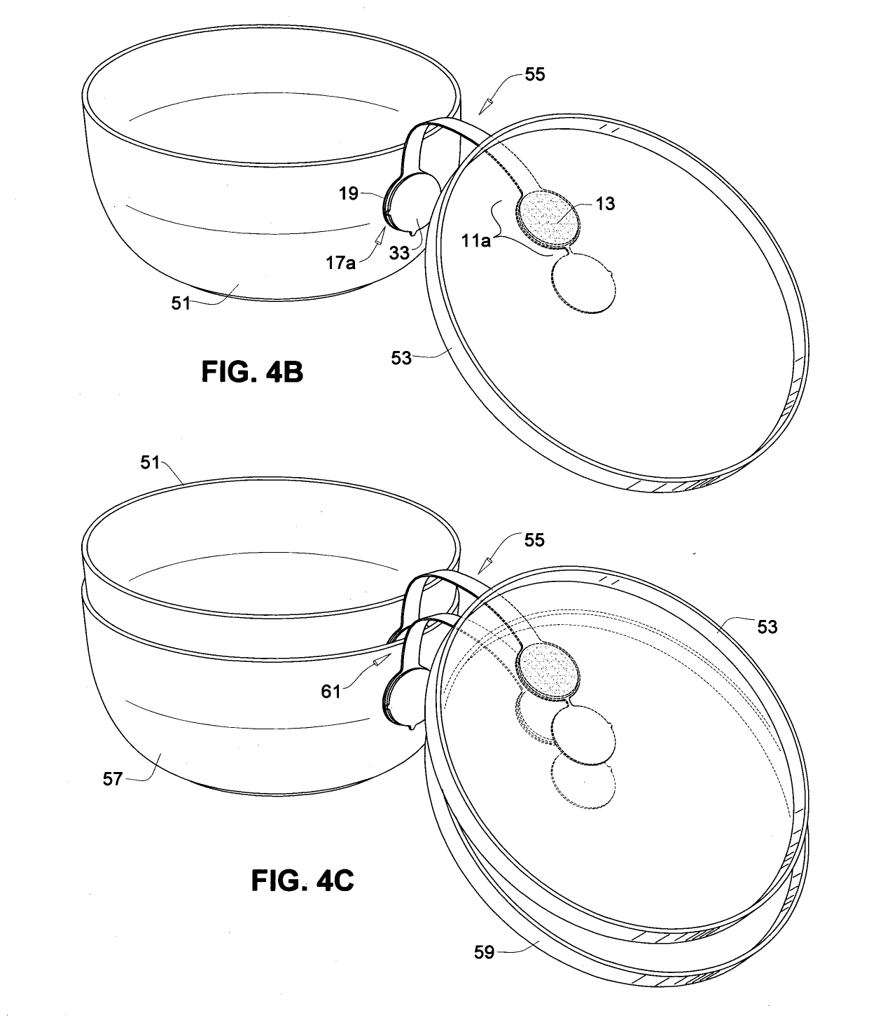

Referring to FIG. 4A an embodiment of the present invention is shown in use affixed to a container 51 and a mating lid 53. The lid attachment member 11a is affixed via its adhesive 13 to lid 53, the container attachment member 17a is affixed via its adhesive 19 to container 51, and thus the flexible line member 15a establishes a tether between container 51 and lid 53. Protective strip section 31 is shown in an open position with its protective surface laying flat on lid 53. Protective strip section 33 is shown in a position with its mechanical retention (not in view) engaged and subsequently organized neatly with the attachment member 17a.

Furthermore, if lid 53 is subsequently removed from container 51 as shown in FIG. 4B, the lid 53 remains associated with the container 51 until it is desired to once again mate the two parts together. Thus the present invention 55 will maintain the association between a lid 53 and container 51 through any use, including storage of food or other items, hand or dishwasher washing, and opening and closing operations. If the adhesives 13,19 are a permanent adhesive then the present invention may remain in association with the container 51 and lid 53 for the life of the components. In the alternative if the adhesives 13,19 are a gummy or other non-permanent adhesive then one or both of the container attachment member 17a and lid attachment member 11a can be repositioned or removed entirely such that the present invention 55 can be stored for future use or affixed to a different container and lid set. Furthermore a user may desire to leave the present invention 55 affixed to container 51 but detach lid 53, or vice versa, to wash or store the components separately. In such case a removed attachment member may now be covered by its adjacent protective strip section until re-use is desired. Referring still to FIG. 4B protective strip section 33 is shown in a position with its mechanical retention (not in view) engaged and subsequently organized neatly with the attachment member 17a, protruding minimally from the outer surface of container 51, enabling the operation of stacking multiple nesting containers.

Referring now to FIG. 4C container 51 is shown nested with container 57. Lids 53,59, tethered in association to their respective containers 51,57 via the present invention 55,61, stack neatly as well.

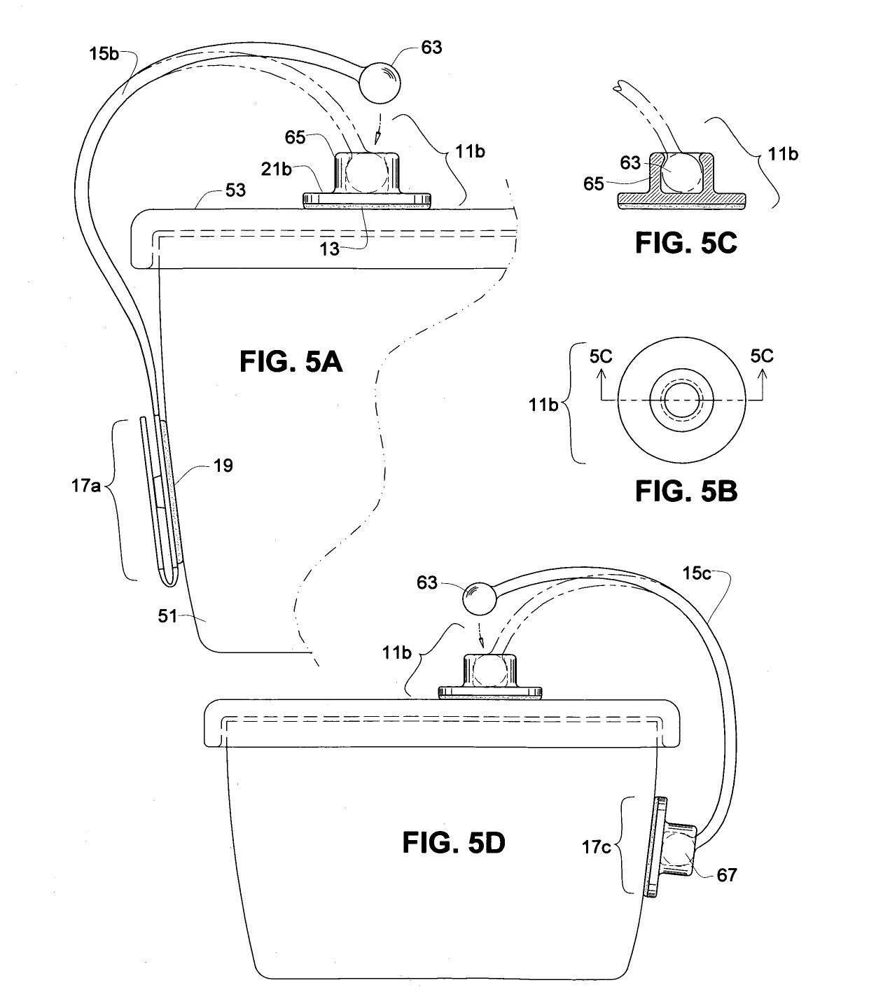

The present invention may embody at least one of several means by which to mechanically join and subsequently detach the flexible line member from at least one attachment member, one of said means being a ball-and-socket arrangement. Referring now to FIG. 5A, lid attachment member 11b is shown having a pad 21b with integral socket recess 65 and affixed to lid 53 with adhesive 13. Container attachment member 17a is shown molded integrally with flexible line member 15b and affixed to container 51 with adhesive 19. Flexible line member 15b has at least one spherical end 63 intended to mate with socket recess 65 in a snap-fit ball-and-socket arrangement. FIG. 5B shows attachment member 11b in plan view and refers to FIG. 5C showing attachment member 11b in section, detailing the snap-fit mechanism between the spherical end 63 and recess 65. Referring to FIG. 5D an alternative is shown wherein flexible line member 15c has two spherical ends 63,67 such that either or both ends may be attached and subsequently detached from attachment pads 11b and 17c if the user so desires. Such embodiments of the present invention as described in FIGS. 5A-5D would function well in arranging heavier and/or higher quality lid and container sets, though said embodiments should not be limited as such in their use.

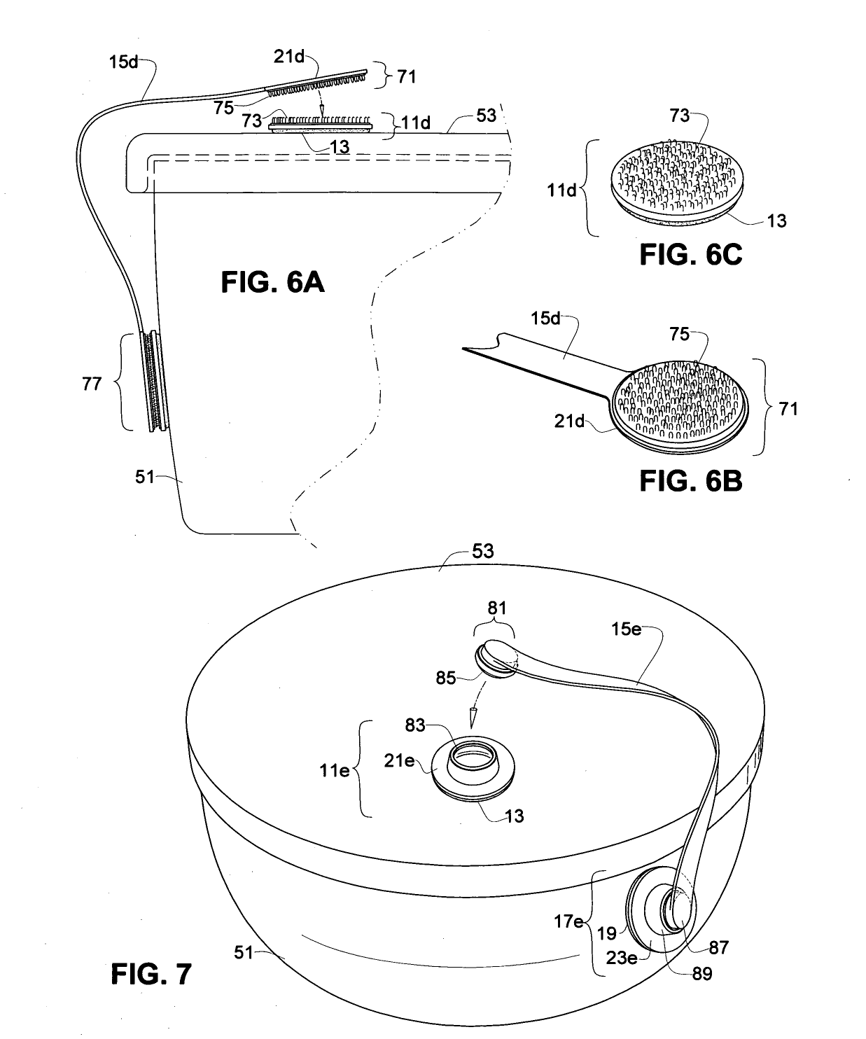

Referring to FIG. 6A the present invention is shown to embody a hook-and-loop means by which to mechanically join and subsequently detach the flexible line member 15d from lid 53 and container 51. At least one end 71 of flexible line member 15d is molded with an integral and preferably circular or elliptical pad 21d with a surface on which a loop element 75 of said hook-and-loop mechanism is affixed as shown in FIGS. 6A and 6B. The other end 77 of flexible member 15d may be identical to first end 71 or may comprise as in FIGS. 4A and 5A a single-part attachment member 17a. Referring to FIG. 6C, lid attachment member 11d is a pad comprising a hook element 73 of said hook-and loop mechanism and adhesive 13, and has similar surface area to loop element 75 affixed to pad 21d as in FIG. 6C. Hook-and-loop elements 73,75 preferably have submersible geometry such that a secure attachment can still be made if said hook-and-loop surfaces are wet; one specification of said elements being 3M DUAL-LOCK.

Referring now to FIG. 7 a further embodiment of the present invention comprises a flexible line member 15e with at least one press-snap end 81. At least one attachment member lie comprises a press-snap socket 83 preferably molded with circular pad 21e having adhesive 13 for affixing to lid 53. Said end 81 has a press-snap button 85 with geometry allowing it to mate with press-snap socket 83 providing a mechanical join, and also allowing subsequent separation if the user desires. The flexible line member 15e may also have a second press-snap end 87, here shown mated with attachment pad 17e, said attachment pad 17e having a press-snap socket 89 preferably molded with circular pad 23e and affixed to container 51 with adhesive 19.

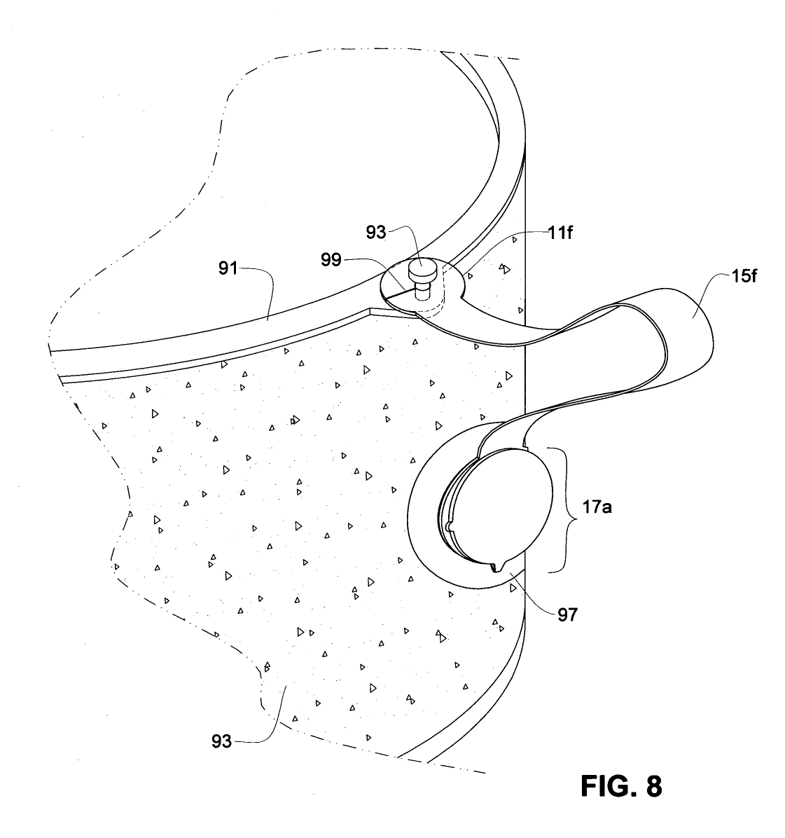

The present invention may also used in conjunction with containers and lids having attachment member retaining means as shown in FIG. 8. Lid 91 is molded with an attachment stud 93, and container 95 is shown to have a smooth non-textured region 97 such that would allow better adhesive adhesion of attachment member 17a. Flexible line member 15f is shown molded integrally with container attachment member 17a and lid attachment member 11f. Attachment member 11f has a hole and slot 99 sized to clip around attachment stud 93 thusly completing the tether between container 93 and lid 91. There may exist other embodiments of lids and containers having attachment member retaining means, and the attachment of the appropriate embodiment of the present invention to said means shall not be limited to the scenario just described.

Thus, I have described the preferred embodiments of the invention with respect to the best mode with the understanding that features of the present invention are capable of being modified and altered without departing from the teaching hereof. Therefore the present invention should not be limited to the precise details herein but should encompass the subject matter of the claims that follow and their equivalents.

I claim:

1. An apparatus for retaining a lid in association with a container, said container having opening to which the lid fits in a closed position and an open position in which the lid is not affixed to the opening, comprising:
at least one lid attachment member, said lid attachment member having means for being affixed to at least one lid;
at least one container attachment member, said container attachment member having means for being affixed to at least one container;
a flexible line member having a first end and a second end, said first end attached to said lid attachment member and second end attached to said container attachment member, said flexible member having a length to allow said first end to be secured to a lid by said lid attachment member and said second end secured to a container by said container attachment member while the lid is in a first open position and in a second closed position.

2. The apparatus of claim 1 wherein said lid attachment member is a flexible pad having an adhesive for sticking to a lid.

3. The apparatus of claim 1 wherein said container attachment member is a flexible pad having an adhesive for sticking to a container.

4. The apparatus of claim 2 or 3 wherein said adhesive presents one or more surfaces for forming an adhesive bond that may be either substantially permanent or substantially repositionable and where said adhesive is selected from the group consisting of a gummy adhesive and other pressure sensitive adhesive.

5. The apparatus of claim 2 or 3 wherein said adhesive is non-toxic.

6. The apparatus of claim 2 or 3 wherein said adhesive is dishwasher safe.

7. The apparatus of claim 4 further comprising a protective strip, said protective strip covering said adhesive to prevent said adhesive from attaching to material and things other than a lid or container and removable to expose the adhesive at the time it is desired to affix the lid or container attachment member to a respective lid or container.

8. The apparatus of claim 7 wherein said protective strip is integral to said attachment member to allow said attachment member to be removed from a lid or container and said protective strip to cover said adhesive.

9. The apparatus of claim 8 wherein said attachment member has a protective strip section and an adhesive section, said protective strip section and said adhesive section separated by a connective strip or a fold.

10. The apparatus of claim 9 wherein said protective strip section has two positions; in a first position the protective strip section is folded back and mechanically secured to a non-sticky side of said adhesive section with a snap or clip, and in the second position the protective strip is covering the adhesive.

11. The apparatus of claim 1 further wherein at least one of said lid attachment member and said container attachment member comprise a ball and socket element, said ball affixed to or integral with said flexible member and said socket element having an opening for snap receiving said ball on said flexible member and having mounting means.

12. The apparatus of claim 1 further wherein at least one of said lid attachment member and said container-attachment member comprise a hook and loop element, said hook and loop element having at least one hook surface and at least one loop surface, at least one of said hook surface and said loop surface affixed to or integral with said flexible member and said remaining surface having mounting means to allow the hook and loop element to be separated.

13. The apparatus of claim 1 further wherein at least one of said lid attachment member and said container attachment member comprise a press-snap element, one part of said press-snap affixed to or integral with said flexible member and said respective mating part of said press-snap having mounting means to allow the press-snap element to be separated.

14. The apparatus of claim 1 further comprising at least one lid and at least one container.

15. The apparatus of claim 14 wherein at least one of said lid and said container have attachment member retaining means.

16. The apparatus of claim 15 wherein said attachment member retaining means is selected from the group consisting of adhesive retaining surface, a molded socket element, a molded clip opening, a molded attachment stud, a latch, or a hole.

17. A method organizing and for retaining a lid in association with a container said container having opening to which the lid fits in a closed position and an open position in which the lid is not affixed to the opening, said method comprising the steps of:
providing an apparatus having at least one lid attachment member, said lid attachment member having means of being affixed to at least one lid; at least one container attachment member, said container attachment member having means of being affixed to a container; and a flexible line member having a first end and a second end, said first end attached to said lid attachment member and second end attached to said container attachment member, said flexible member having a length to allow said first end to be secured to a lid by said lid attachment member and said second end secured to a container by said container attachment member while the lid is in a first open position and in a second closed position;
affixing the container attachment member to said container and said lid attachment member to said lid to organize and retain said lid in association with a container.

18. The apparatus of claim 17 wherein said lid attachment member is a pad having an adhesive having means for sticking to a lid and said method comprises the step of sticking said attachment member to a lid.

19. The apparatus of claim 17 wherein said container attachment member is a pad having an adhesive having means for sticking to a container and said method comprises the step of sticking said attachment member to a container.
